(19) United States
(12) Patent Application Publication
(10) Pub. No.: US 2005/0172794 A1
(43) Pub. Date: Aug. 11, 2005

(54) Drive mechanism for the positioning of an actuator, such as a valve, and device for the control of an actuator

(76) Inventors: Heinfried Hoffmann, Frankfurt am Main (DE); Christian Mellinger, Rodgau (DE); Stefan Kolbenschlag, Darmstadt (DE); Karl-Bernd Schartner, Erlensee (DE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/046,210

(22) Filed: Jan. 28, 2005

(30) Foreign Application Priority Data
Jan. 30, 2004 (DE) 10 2004 004 903.3

(51) Int. Cl. F16D 31/00

(52) U.S. Cl. 91/361

(57) ABSTRACT

A drive mechanism for the positioning of an actuator, such as a valve, containing an actuating component that can be coupled with an actuating element of the actuator is described. A driving force unit is provided which provides an actuation in accordance with the operation to the actuating component and a housing in which a part of the actuating component is accommodated. The housing has a passage through which the actuating component extends out of the housing to the actuator for transmitting the actuation. Within the housing, a position sensor is accommodated for recording the position of the actuating component and for generating an electric positioning signal for transmission to a control and/or regulating device.

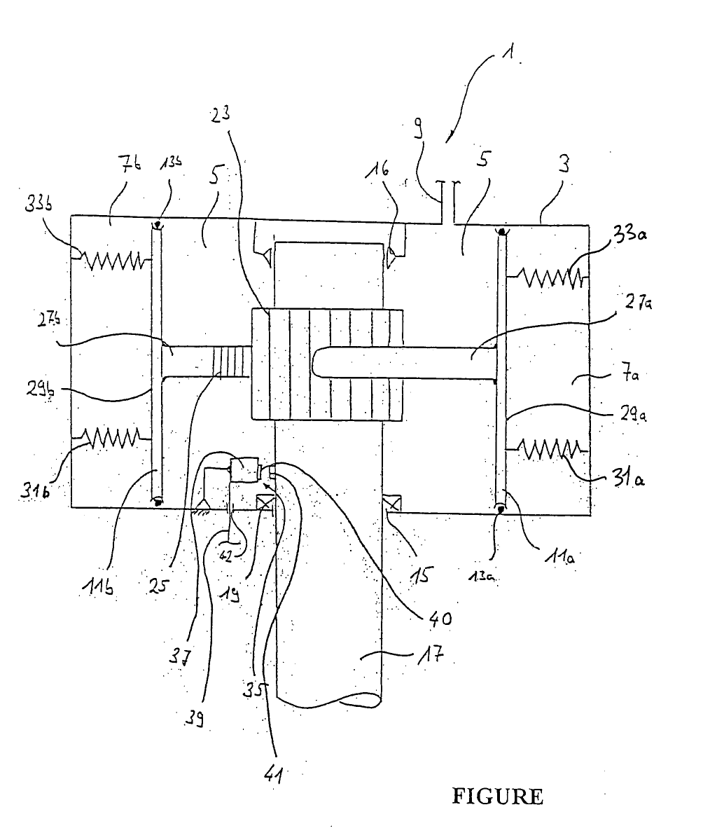

### FIELD OF THE INVENTION

The invention concerns a drive mechanism for the positioning of an actuator, such as a valve, wherein a housing of the drive mechanism is used for at least the partial accommodation of the component that is to be actuated and that can be coupled with the actuator for transferring an actuation.

The invention is used particularly in the field of chemical processing industry or in mineral oil processing or gas processing industry and above all in the control of fluid circulation processes, in which the most reliable valves are necessary.

### BACKGROUND OF THE INVENTION

In WO 02/31363 a pneumatic drive mechanism is described for the positioning of a valve wherein a pneumatic control unit is flange-mounted on the housing of the drive mechanism with which the desired compact construction with convenient means of control is achieved for the actuator-valve-control device arrangement. The control unit contains a mechanical sensor that has a tappet rod (valve lifter) coupled with an actuating component of the actuator. The tappet rod transfers the actuation of the actuating component into the housing of the control unit in order to indirectly sense the position of the actuator. In addition, an electronic circuit is accommodated in the housing of the control unit for generating an electric control and regulation signal. The use of mechanics for the transfer of actuation into the governing house is disadvantageous since a large number of components and great mechanical effort are necessary to accomplish it. Apart from that, a mechanical tappet rod arrangement always has a mechanical clearance that distorts the recorded position signals with respect to the actual position of the actuator. Furthermore, due to the mechanical clearance, the mechanism is susceptible to wear and tear and contains an avoidable hysteresis characteristic in the control-oriented evaluation of the position signal of the actuating component.

### SUMMARY OF THE INVENTION

The task underlying the invention at hand is to overcome the disadvantages of the prior art, and in particular to create a controllable drive mechanism that has a simple complete construction and whose controlling and regulating abilities can be operated reliably.

This task is solved by the characteristics of claim 1. According to it, a position sensor is accommodated in the housing of a drive mechanism for recording the position of an actuating component of the drive mechanism and for generating an electric position signal for transmission to a control and/or regulating device.

By accommodating the sensor in the housing of the drive mechanism, a mechanical coupling leading from the housing of the drive mechanism for determining the position of the actuating component can be omitted. Furthermore, there is also no need of expensive sealing for mechanical sensing devices for recording the position of an actuator, in order to seal the mobile components of the known coupling mechanics with respect to the housing of the drive mechanism. The transmission of position information to the control and/or or regulating device can take place electrically, whereby the existing fluid-tight bushing of the housing is used. In addition, the known housing for the regulation and control device is equipped with a relatively robust casing due to the susceptible mechanical coupling. According to the invention at hand, the sensor is sufficiently protected by the housing of the drive mechanism. The accommodation of a position sensor that generates an electric signal representing the position of the drive shaft in the housing of the drive mechanism surprisingly proved in long-term tests that an essentially dependable control and/or regulation of the drive mechanism is possible. Above all, the idea contained in the present invention enables a redundant construction without requiring the use of complex and expensive mechanical construction.

A further special advantage of the procedure in accordance with the present invention of accommodating the position sensor in the housing of the drive mechanism is that the usual bushing of the actuating component through the housing of the drive mechanism to an external control unit can be omitted and thus a sealing arrangement bearing up against and withstanding high pressure in certain circumstances in the housing of the drive mechanism is no longer necessary for this passage. In this manner the manufacturing composition of the housing of the drive mechanism is considerably reduced.

In a preferred embodiment of the present invention, the housing of a drive mechanism borders a pressure chamber, particularly a pneumatic pressure chamber, and a resetting chamber. The position sensor can be accommodated in the pressure chamber, wherein for this purpose, a sensor, such as a sensor foil, and an electronic circuit should be used that can withstand the increased ambient pressure without falsifying the measured results.

In a preferred embodiment of the present invention, the housing of the drive mechanism is provided with a pressure-tight bushing, particularly a groove for accommodating an electric connection, preferably a cable, that is connected to the sensor. The groove is preferably positioned in the vicinity or in a seal retainer of the housing.

In a preferred advanced embodiment of the invention, the sensor is arranged close to the section of the actuating component that exits the housing, particularly the drive shaft. Erroneous measurements can thus be avoided.

In a preferred advanced embodiment of the present invention, the sensor has a sensor foil that responds to essentially punctiform pressure. The sensor foil can be attached to the actuating component as well as inside the housing of the drive mechanism. The sensor foil is characterized by a particularly flat construction style and can be exposed to very high ambient pressure without adversely affecting the measurement results. The sensor foil contains on its scanning side a protective film that covers a conductive layer arranged at a distance from a customary potentiometer connected to a voltage source. The protective foil and also the conductive layer have an elastic form. The sensor foil is attached to a slider that exerts a pressure on the sensor foil that can be predetermined. Two contacts are materially arranged at the ends of the sensor foil for measuring an electrical value such as the measurement of resistance, the amperage, or the voltage. Each position of the dent of the slider at the sensor foil generates a measured value that corresponds to a predetermined position of the actuating component. This sensor foil arrangement is of an advantage insofar as grease or oil in the housing of the drive mechanism does not influence the measurement reading of the sensor foil and the sensor foil is easily mountable due to its adjustable geometry and due to a self-adhesive layer opposite to the protective foil.

In an alternative embodiment of the sensor, a non-contact scanning magnet fluid track is provided.

The magnet-fluid track particularly preferably comprises a channel- or tube-shaped fluid channel that contains a carrier fluid, particularly a carrier liquid that is preferably a migrating oil and magnetizable particles, such as ferrite powder, suspended in the fluid track. A magnet can be attached to the fluid track such that the magnetizable particles concentrate at a region of the fluid track that is in close proximity to the magnet leading to a high concentration of particles in this region. Depending on the position of the region of increased concentration of particles, varying electrical measurement values can be tapped at the measurement contacts that are arranged essentially at the end of the fluid track. The fluid track can be attached to the actuating component and also to a section of the housing, whereby the magnet is arranged to correspond to the opposite point of the other part.

In order to improve the redundancy of the regulation and/or control of the drive mechanism, that is, in order to eliminate the malfunction of the position recording with the utmost probability, in a preferred advanced embodiment of the invention at least two sensors are accommodated in the housing of the drive mechanism for recording the position of the actuating component. The sensors have an electric connection to the control and/or regulating device. Preferably, the two (or more) sensors have an unequal construction wherein it is preferred that they work according to different physical measuring principles. Particularly in the design/configuration of the two (or more) sensors as a sensor foil or magnet-fluid track, the latter are arranged opposite each other, particularly axially and at the same height. In order to avoid a simultaneous contact loss of the slider or of the magnet, to the sensor foil or to the fluid track, at least two fluid tracks or at least two sensor foils are preferably arranged offset at an angle, preferably 120°.

In an advanced embodiment of the invention, the two (or more) sensors are constructed in such a manner that in the event of an eigenfrequency (natural frequency) of an exciter of a sensor, both sensors do not fail simultaneously. The varying resonant resonant frequencies can be formed by varying the masses in case of a sensor foil such that the two (or more) sliders access the sensor foil with varying contact pressure.

In order to compensate for measuring errors induced by temperature changes, in a preferred configuration of the invention, a potentiometer is provided to which an ohmmeter that records the temperature changes is connected.

Furthermore, potentiometers of at least two sensors can each be arranged at a section of the housing that lies close to the passage of the actuating component or at a varying radius to a longitudinal axis of the actuating component.

Furthermore, the invention concerns a device for regulating and controlling an actuation of an actuator such as a valve that can be actuated by an actuating component of a drive mechanism. The control system according to the invention contains a position sensor for recording the position of the actuating component. The disadvantages of known control systems are resolved by the fact that the sensor is accommodated in a housing that at least partly accommodates the actuating component. A preferred design of the control system can be implemented according to the detailed description above with regard to the drive mechanism.

### BRIEF DESCRIPTION OF THE DRAWING

Further attributes, characteristics, and advantages of the invention are clearly illustrated in the following description of a preferred design of the invention on the basis of the accompanying drawing, in which the drawing illustrates an elementary diagram of a rotary actuator (part-turn valve actuator) in accordance with the present invention.

### DETAILED DESCRIPTION OF THE ILLUSTRATED EMBODIMENT

The rotary actuator 1 illustrated in the FIGURE contains a housing for a drive mechanism 3, that encloses a compression-loaded pressure chamber 5 and resetting chambers 7a, 7b. A control air feed line 9 empties into the pressure chamber 5. Control air is fed into the pressure chamber 5 via the control air feed line 9 by a control and/or regulating unit that is not elaborately illustrated.

The resetting chambers 7a and 7b are separated from each other by partition walls 11a and 11b to be airtight and pressure-tight.

The translationally displaceable partition walls 11a and 11b contain at their ends seals 13a and 13b that prevent a fluid exchange between the resetting chambers 7a and 7b and the pressure chamber 5.

The housing 3 contains in the center a passage 15 that is arranged in a housing wall. An actuating component in the form of an adjustment axle 17 extends through the passage 15. The adjustment axle 17 is pivot- and swivel-mounted 16 with reference to the housing 3. The passage 15 is sealed to be fluid-tight and pressure-tight opposite the outer atmosphere by means of a seal 19. The wall of the housing 3 opposite to the housing wall with the passage 15 is designed without a passage for the adjusting axle.

Within the housing 3, the adjusting axle 17 has a toothed wheel that works together with a suitably designed drive spline 25 of two drive arms 27a and 27b. The drive arms 27a and 27b are fastened to the translationally displaceable partition walls 11a and/or 11b and translationally relocatable over the partition wall 11a and/or 11b such that a pivoting S is conveyed to the adjusting axle 17 by the engagement of the tooth wheel 23 and the splines 25.

A couple of pressure springs 31a and 33a and 31b and 33b are arranged on sides 29a and 29b of the partition walls 11a and/or 11b facing away from the adjusting axle 17 in the resetting chambers 7a and 7b. The pressure springs 31a, 31b, 33b, 33a are supported at the housing 3 and act upon the partition wall 11a and 11b with a resetting force that is aimed at the adjusting axle 17 and opposite to each other.

If control air is fed to the rotary actuator 1 via the control air feed line 9 by a control device (not illustrated), thus increasing the pneumatic pressure in the pressure chamber 5, an actuation of the partition wall-drive arm-arrangement away from the adjusting axle 17 is caused, whereby a determined actuation is conveyed to the adjusting axle 17. In this manner a valve (not illustrated) with which the adjusting axle 17 is coupled is brought into a position that is calculated to be optimal by the control system. By letting off the control air and with it the internal pressure of the pressure chamber 5 via the control air feed line 9 or another outlet valve (not illustrated), the pressure springs 31a through 33b cause a movement of the partition wall-arm-arrangement on the adjusting axle 17, whereby the adjusting axle 17 is swiveled in an opposite direction.

A position sensor 35 is accommodated in the pressure chamber 5 near the output end of the passage 15 of the housing 3. The position sensor technology uses the sensor 35 for recording the position and/or the pivoting of the adjusting axle 17 and an electronic circuit 37 for generating an electric position signal representing the recorded position. The position signal is fed to a control device (not illustrated) via a line 39 that arrives outside via a borehole 42 in the housing 3.

The electronic circuit 37 of the position sensor 35 is attached to the housing 3. In one embodiment, the sensor 35 contains a fluid track 40 that is accommodated hermetically in a foil housing, whereby the fluid carries magnetizable particles. A potentiometer (not elaborately illustrated) is provided at the fluid track 40 that is electrically connected to the electronic circuit 37.

A magnet 41 affixed to the adjusting axle 17 is positionable with respect to the fluid track 40 such that due to the influence of magnet 41, the magnetizable particles concentrate at a section of the fluid track 40 opposite to the magnet 41 building an increased concentration of magnetizable particles in this area. This increase in the concentration of magnetizable particles can be recorded by the potentiometer, whereby the position of the adjusting axle 17 can be identified, generating a position signal.

A control signal generated by the electronic circuit 37 from the position signal can be used to monitor and/or adjust the desired position of the valve (not illustrated elaborately).

The features and characteristics manifested in the above description, figures, and claims can be of importance both individually and also in any combination to different embodiments for the realization of the present invention.

### LIST OF REFERENCES

1 Rotary actuator
3 Housing of the drive mechanism
5 Pressure chamber
7a, 7b Resetting chambers
9 Control air feed line
11a, 11b Partition wall
13a, 13b Seals
15 Passage
17 Adjusting axle
19 Seal
23 Toothed wheel
25 Splines
27a, 27b Drive arms
29a, 29b Side of the partition wall facing away
31a, b, 33a, b Pressure springs
35 Sensor
37 Electronic circuit
39 Cable
40 Fluid track
41 Magnet
42 Borehole
S Actuation

1. A drive mechanism for the positioning of an actuator containing an actuating component that can be coupled with an actuating element of the actuator, a driving force unit that provides an actuation to the actuating component, and a housing in which a part of the actuating component is accommodated and that has a passage through which the actuating component extends out of the. housing to the actuator for the transmission of the actuation, characterized by the fact that in the housing, a position sensor is accommodated for recording a position of the actuating component and for generating an electric position signal to be transmitted to a control and/or regulating device.

2. The drive mechanism according to claim 1 characterized by the fact that the housing contains at least in part a pressure chamber and a resetting chamber, whereby the position sensor is accommodated in the pressure chamber.

3. The drive mechanism according to claim 1 characterized by the fact that the housing has at least a fluid-tight, particularly pressure-tight passage, by way of which the electric position signal can be transferred to the exterior of the housing to the control and/or regulating device.

4. The drive mechanism according to claim 1 characterized by the fact that inside the housing a groove is provided for accommodating an electric connection connected to the position sensor and the groove is designed particularly at or in a seal retainer of the housing in the area of the passage.

5. The drive mechanism according to claim 1 characterized by the fact that the position sensor senses the position of the actuating component adjacent to the passage.

6. The drive mechanism according to claim 1 characterized by the fact that the position sensor has an electronic circuit for converting the position signal into an electric control signal, whereby particularly the electronic circuit is arranged in the immediate vicinity of the position sensor.

7. The drive mechanism according to claim 1 characterized by the fact that the position sensor contains a sensor foil that responds to pressure.

8. The drive mechanism according to claim 1 characterized by the fact that the position sensor has a fluid track with electrical measuring contacts that can be connected to a meter, wherein the fluid track has a hermetically sealed channel-shaped housing in which a carrier fluid with magnetizable particles suspended in it are trapped, and wherein a magnet is attached to another portion of the drive mechanism such that the magnet is positionable with the fluid track to indicate the position of the actuating component.

9. The drive mechanism according to claim 8 characterized by the fact that the fluid track is attached to a potentiometer via which the position of the magnet is electrically recorded whereby depending on a concentration of magnetizable particles in the fluid track relative to the measuring contacts an electric measurement value corresponding to the position of the magnet can be recorded by the potentiometer.

10. The drive mechanism according to claim 1 characterized by the fact that at least two sensors independent of each other are accommodated in the housing of the drive mechanism for recording the position of the actuating component, whereby the at least two sensors have varying constructional systems and work according to different physical measuring principles.

11. The drive mechanism according to claim 10 characterized by the fact that the at least two sensors each include a pressure-sensitive sensor foil or a fluid track whereby the two sensors are arranged opposite to each other axially at approximately the same height and at an angular offset of approximately 120°.

12. The drive mechanism according to claim 10 characterized by the fact that the at least two sensors are designed with different resonant frequencies so that that sensors designed as sensor foils have at least two sliders that are designed to apply a varying contact pressure to the sensor foil.

13. The drive mechanism according to claim 10 characterized by the fact that potentiometers of the at least two sensors are arranged at a section of the housing that lies in the vicinity of the passage or at a varying radius to a longitudinal axis of the actuating component.

14. The drive mechanism according to claim 1 characterized by the fact that a potentiometer of the position sensor is connected to an ohmmeter for monitoring the temperature of the chamber in which the position sensor is accommodated.

15. A device for controlling an actuation of an actuator that can be positioned by an actuating component of a drive mechanism, whereby the device has a position sensor for recording a position of the actuating component and for generating an electric position signal for transmission to the device, in which the position sensor is accommodated in a housing that at least partly accommodates the actuating component.

16. The device according to claim 15 characterized by the fact the device is configured to functionally collaborate with a drive mechanism configured in accordance with claim 1.
